(19) United States
(12) Patent Application Publication
(10) Pub. No.: US 2014/0074507 A1
(43) Pub. Date: Mar. 13, 2014

(54) TARGETED ADVERTISING FOR ON-LINE PHYSICIAN CARE SERVICE

(71) Applicant: Jonathan L. Simon, Temple, PA (US)

(72) Inventor: Jonathan L. Simon, Temple, PA (US)

(21) Appl. No.: 13/961,154

(22) Filed: Aug. 7, 2013

Related U.S. Application Data
(60) Provisional application No. 61/683,880, filed on Aug. 16, 2012.

(51) Int. Cl. G06Q 30/02; G06F 19/00

(52) U.S. Cl. CPC G06Q 30/0269; G06F 19/3418
USPC 705/3

(57) ABSTRACT

An on-line physician care system in which, while the patient waits for a receptionist, the system displays targeted advertising and other information to that patient. This type of targeted information is similar to a patient leafing through the pages of a magazine in the doctor's office, and reviewing the advertisements and other information in that magazine. Additional advertising that can be more specifically targeted to the patient can be displayed during the time that the patient is transferred to and holds in a doctor's wait queue.

### FIELD OF INVENTION

Internet based, video conferencing, web applications have been developed that provide physician care service to its users on-line. One such system has a network of board certified, primary care physicians who respond to patient requests within a few minutes, saving the patient 2 to 4 hours of time while providing basically the same visual and personal physician interaction experienced during a traditional office visit. The physician is able to diagnose common ailments or address a medical concern, and create medication prescriptions, which are forwarded to a pharmacy of the patient's choice through a virtual office visit.

### BACKGROUND

When a patient connects to one known on-line physician care system, such as the Rapid Remedy™ system owned by the assignee of the present application, the system places the patient on a wait queue, which is similar to a patient walking into a doctor's office and sitting in the waiting room. The patient is waiting for a receptionist to answer the call. The wait period is under 2 minutes typically.

When the system receptionist answers the call, the receptionist asks the patient for several pieces of information. The receptionist asks for the patient's name, the last four digits of the patient's social security number, the patient's date of birth, and the reason for the call. If the patient wants to speak with a licensed doctor and/or other health care provider, the receptionist transfers the patient to the doctor's wait queue, which is similar to a patient signing a log sheet at a doctor's office and returning to a seat in the waiting room. Another brief period of time ensues, while the patient waits for the doctor to answer the call.

### SUMMARY

While that patient waits for a receptionist, the system according to the invention displays targeted audio and/or video advertising and other information to that patient via the patient's computing device. This type of targeted information is similar to a patient leafing through the pages of a magazine in the doctor's office, and reviewing the advertisements and other information in that magazine.

The system can also display targeted advertising and other information to that patient via the patient's computing device during this initial receptionist wait period based on the patient log-in information stored in the system server, an IP address or possibly other system recognized information from the patient's computing device.

After the receptionist gathers information on the patient and the particular issue for the virtual doctor's office visit via a receptionist computing device, additional advertising that is more specifically targeted to the patient can be displayed by the system during the time that the patient is transferred to and holds in a doctor's wait queue.

The system preferably includes a database structure that collects patient demographics, pharmacy information, subscribing company information, patient usage, visits, prescriptions, delivery dates, and other information. Other information includes company product information, advertisements, and promotions in the form of electronic media.

Preferably, the system's patient base includes independent patients (which can be private parties, students, retirees, etc.) and employees of various private and/or public entities. These private and/or public entities, such as businesses, government offices, etc., can subscribe to the service and provide access as an employee benefit. Employees' family members can access the system as well. The system's users have known demographics, including age, gender, and address based on the user subscriptions. A history of previous visits is also stored in the system memory for each of the patient/user, providing the ability to further tailor and target advertising to a specific patient's needs. The system preferably also keeps a history of prescriptions which have been ordered from various pharmacies by a particular patient.

Various advertisers may have an interest in advertising on the system. For example, independent pharmacies have an interest in advertising to the system's patients based on location or other data, or may wish to advertise in general. Pharmaceutical companies, prosthetic companies, and others may have an interest in advertising various products to patients based on patient symptoms and/or history. Prosthetics companies may have an interest in the system's patients. Additionally, patients should have an interest in these companies' products that are pertinent to the patient's issues and demographics. Furthermore, patients should appreciate that the waiting period provides them with interesting reading materials and valuable targeted advertising that fill this time.

Companies can purchase advertising space and time on the system and can provide content directly and/or through the system's ad server system. Companies can list their products and develop advertising materials in the form of electronic media that conforms to the system standards or guidelines in order to increase effectiveness. For example, key words can be assigned to each advertisement, which aid in the selection process via a routine or schema in the system server.

If a company has more than one advertisement with the same or similar key words, each advertisement is assigned a weight which can be used to sort the delivery of those advertisements over time. A company may also opt to deliver their advertisements in a random order.

### BRIEF DESCRIPTION OF THE DRAWINGS

The foregoing summary as well as the following detailed description will be best understood when read in conjunction with the appended drawings. In the drawings:

FIG. 1 is a schematic diagram of an on-line physician care system according to the invention that displays targeted advertising to the patient.

FIG. 2 is a screen print of a computer screen seen by the patient after accessing the system.

FIG. 3 is a screen print similar to FIG. 2 showing the receptionist responding to the initial patient query.

FIG. 4 is a screen print similar to FIG. 3 showing the initial information gathered by the receptionist being confirmed by the patient.

FIG. 5 is screen print similar to FIG. 4 showing the completion of a patent questionnaire by the patient.

FIG. 6 is a screen print similar to FIG. 5 showing the screen as seen by the patient during a wait period during the time the patient is transferred to a doctor's wait queue.

FIG. 7 is a screen print similar to FIG. 6 showing the doctor connected to the system.

FIG. 8 is a screen print similar to FIG. 7 showing the doctor's diagnosis, prescription, notes, as well as a preferred pharmacy where a prescription can be sent.

FIG. 9 is a screen print of a patient sign-off screen when the virtual office visit is completed.

### DETAILED DESCRIPTION OF THE PREFERRED EMBODIMENTS

The following detailed description is of the best presently contemplated mode of carrying out the present invention. However, this description is not to be taken as limiting, but as merely made for the purpose of illustrating the general principles of embodiments of the present invention. The scope of the present invention is best defined by the appended claims.

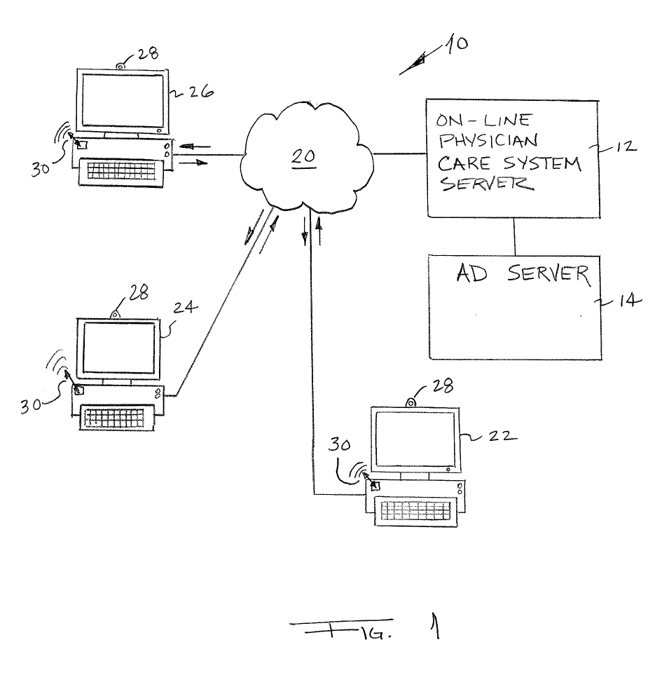

FIG. 1 depicts schematically an on-line physician care system 10 according to the present invention. As shown, the system 10 is preferably implemented via computing devices interconnected through the internet or a plurality of networks. The term “computing device” as used herein refers to any electronic computing device with a processor, such as a PC, tablet, smart phone, mobile telephone, or any other fixed or mobile device that allows internet or network access. The system 10 includes an on-line physician care system server 12 as well as preferably an ad server 14. It is also possible that a single server is used and/or that the on-line physician care system server 12 and ad server system 14 are virtual servers on a single machine. Preferably the server or servers 12, 14 include a processor or a microprocessor of the conventionally known type which executes instructions. Further, the server or servers include a memory or are connected to a memory which may be a random access memory (RAM) or other type of dynamic storage device that stores information and instructions for execution by the processor. Other conventional memories can also be utilized which may include magnetic and/or optical recording medium and corresponding drives.

The server or servers 12, 14 are connected via the internet 20 to at least one patient computing device 22, at least one receptionist computing device 24, and at least licensed service provider, e.g. doctor, computing device 26. Of course, those skilled in the art will recognize that multiple patient computing devices 22 are preferably connected or connectable to the system 10 and one or more receptionist and/or doctor computing devices 24, 26 are also connectable to the system 10. While an internet connection is preferred, other types of connections can be used. Each of these computing devices 22, 24, 26 is preferably equipped with a camera 28, as well as a microphone/speaker 30, typically provided as separate elements on or connected to each of the computers, but represented for the sake of simplicity as a single element 30. For example, the microphone could be wirelessly connected to a computer and be part of a headset and the speaker can be provided as an earpiece rather than using the microphone and speaker located on the computing device 22, 24, 26. As noted above, the computing devices can be a computer, such as a PC, or a mobile device such as a mobile telephone, PDA, tablet computing device, laptop, or other mobile computing device, all of which can be utilized in connection with the system 10. Additional input devices such as keyboards, mouse, pen, voice recognition and/or biometric mechanisms can be utilized in connection with the computing devices 22, 24, 26 to input data or receive data from the system 10.

The functionality of the system 10 is described in further detail below and is preferably carried out via software including instructions that are executed by the processor in the server or servers 12, 14, with the software being contained in a tangible computer-readable medium, such as the memory. The computer readable medium is defined here as a fixed storage medium on which the software instructions are stored and may be a RAM, ROM or other static storage device or material.

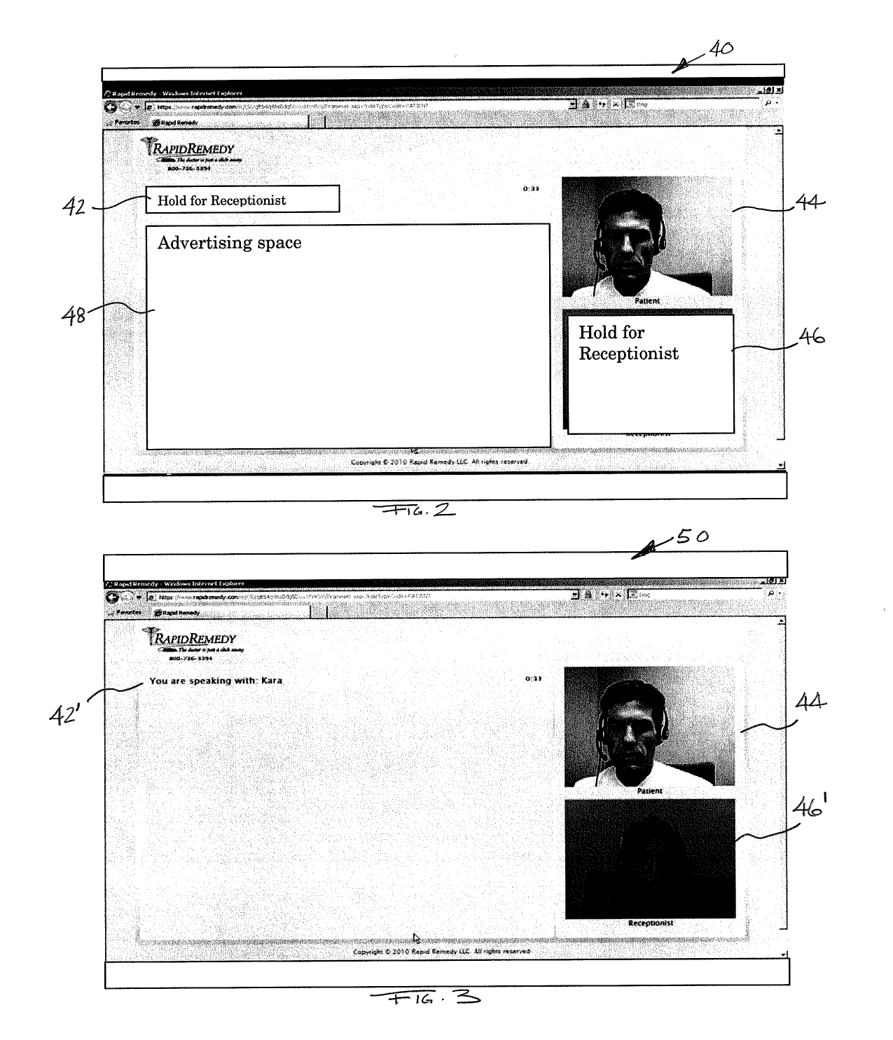

Referring now to FIG. 2, a patient can access the system 10 via the patient computing device 22 and is presented with a screen 40 as shown upon logging in, preferably with a user name and password. As shown, a status line 42 indicates the patient is on hold for a receptionist. Preferably, the screen on the patient's computing device 22 displays a view from the patient's camera 28 in a display area 44 and includes a display area 46 which can display the view from the receptionist computing device 24 or the doctor's computing device 26. An advertising space 48 is provided which can display targeted advertising from the system and/or ad server system 14. This advertising can be based on the patient information in the system server 12, such as the patient's history, company information, and other data gathered on or supplied by the patient and stored in a database in or connected to the system server 12. Advertisers can provide key words or other weighted criteria based on the known patient demographics, such as age, gender, prior medical history, etc. in order for the system 10 to generate and/or show specific advertising targeted to the particular patient. This can be carried out by the processor executing software instructions in the system and/or ad server system 12, 14 which can be connected through the system server 12 to the internet 20 and displayed on the patient's computing device 22. It is also possible for the ad server to collect further data regarding advertisements already shown to the patient and/or to check the system for stored information on the user.

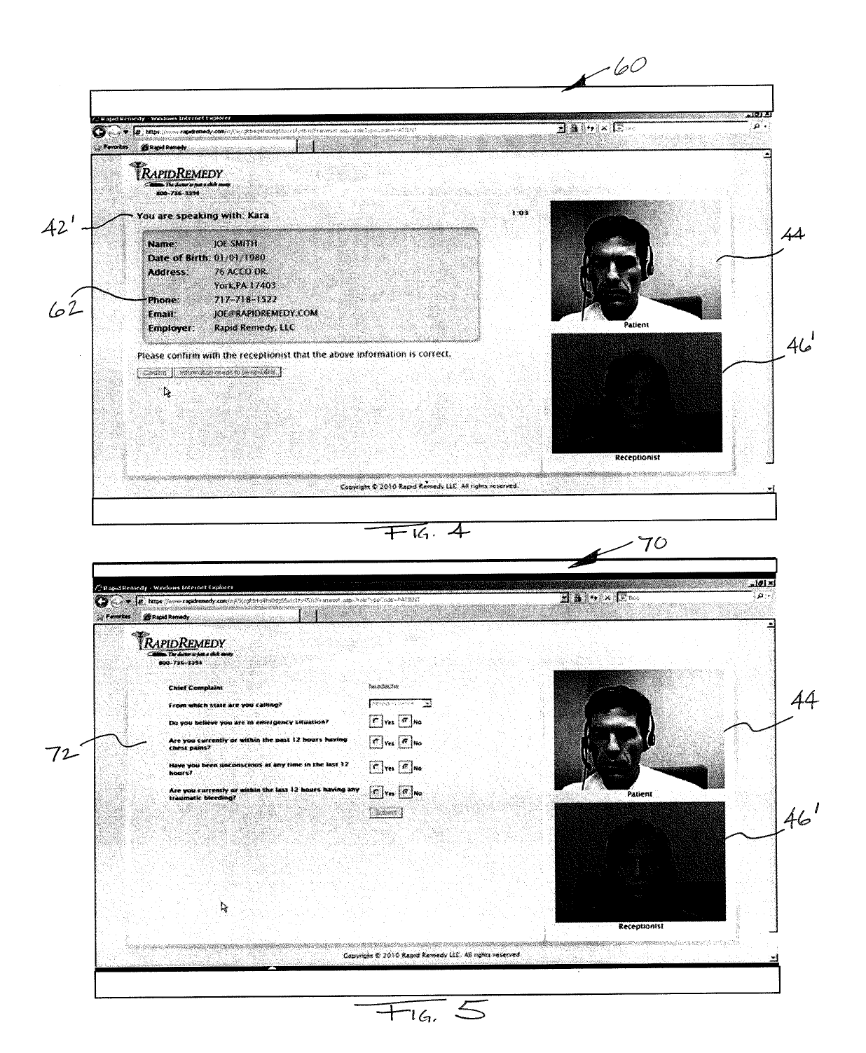

Referring to FIG. 3, the screen 50 is displayed on the patient's computing device 28 as well as preferably the receptionist's computing device 24, with the field 46′ now showing the view from the camera 28 on the receptionist's computer 24 along with an updated status indicator 42′ indicating that the patient is now connected with the receptionist. As shown in FIG. 4 on screen 60, which is similar to screen 50 but with additional patient data 62 that is entered by the receptionist or brought up by the system, patient specific information such as a name, birth date, address, phone, e-mail and employer can be shown. This information can be checked and updated by the patient and/or the receptionist and then confirmed by the patient.

While the receptionist is still connected, the patient can be presented with additional information regarding the reason for the call as shown in FIG. 5 on screen 70 in the patient questionnaire section 72. This can include data entered by the patient or the receptionist, such as the chief complaint, indicated as “headache” as well as additional information, including, for example, the state from which the patient is calling, whether the patient believes that it is an emergency situation, whether other conditions are indicated, such as having chest pains within the past 12 hours, having been unconscious within the past 12 hours, or having traumatic bleeding within the past 12 hours. This can be answered by the patient and/or with the assistance of the receptionist in order to determine whether emergency treatment is warranted. In no case will any advertisement delay the time to see the physician.

After this initial triage by the receptionist, a wait screen 74 is displayed as shown in FIG. 6. Here, the patient is placed in a waiting queue for the doctor and the status bar 42″ is updated to show that the patient is holding for the doctor. Here a second advertising space 78 is provided in which more specific targeted information can again be advertised to the patient as the patient waits in the queue for the doctor. The additional advertising provided in the advertising space 78 can be based on the additional patent demographics gathered by the receptionist and can include information pertinent to the patient's current ailments and/or other data gathered and entered by the receptionist. This additional advertising time also provides a benefit to the patients as they are provided with materials to read while waiting in a queue for the doctor to check their symptoms and answer their questions. This can be assisted by a database query carried out by the system server 12 and/or the ad server 14 based on the patient information, history, company information and/or other information that has been gathered and potential advertisements can then be displayed based on a specific weighting assigned to the patient data that is available for consideration. The system server 12 and/or the advertising server 14 can calculate a weighted list of potential advertisements in such a way as to decrease the possibility of duplicate delivery of similar material on subsequent visits.

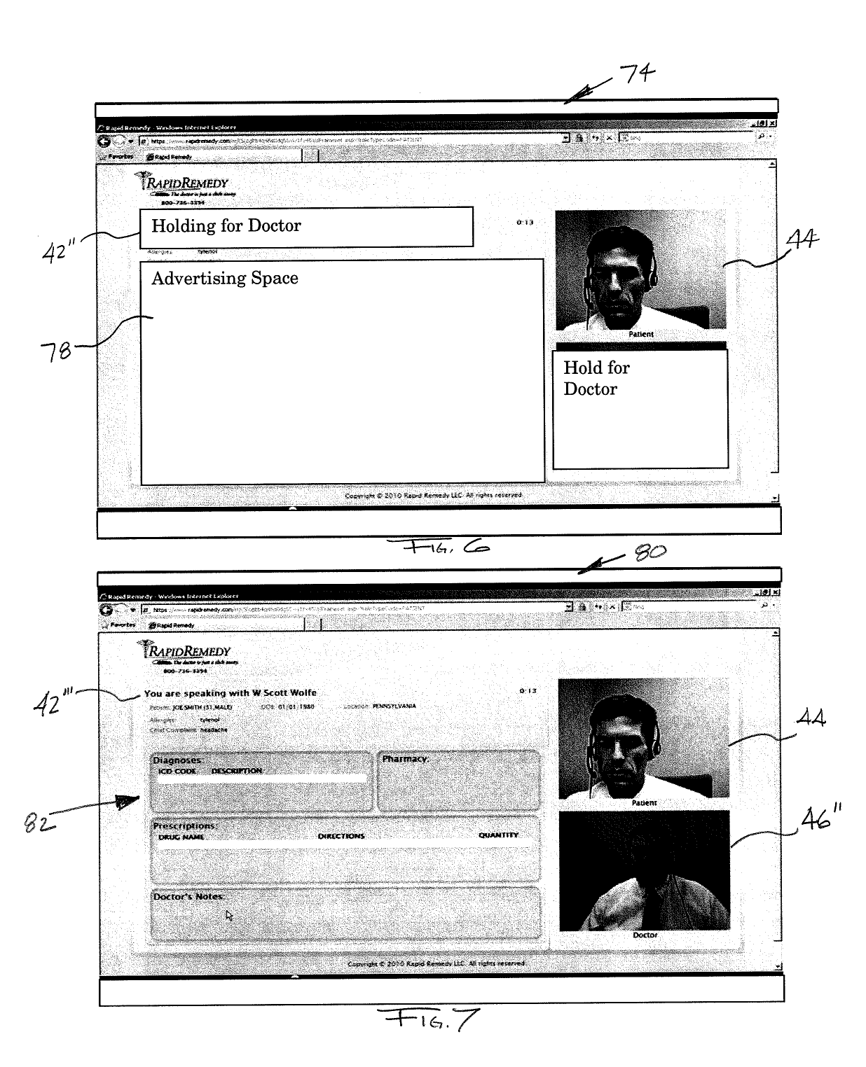

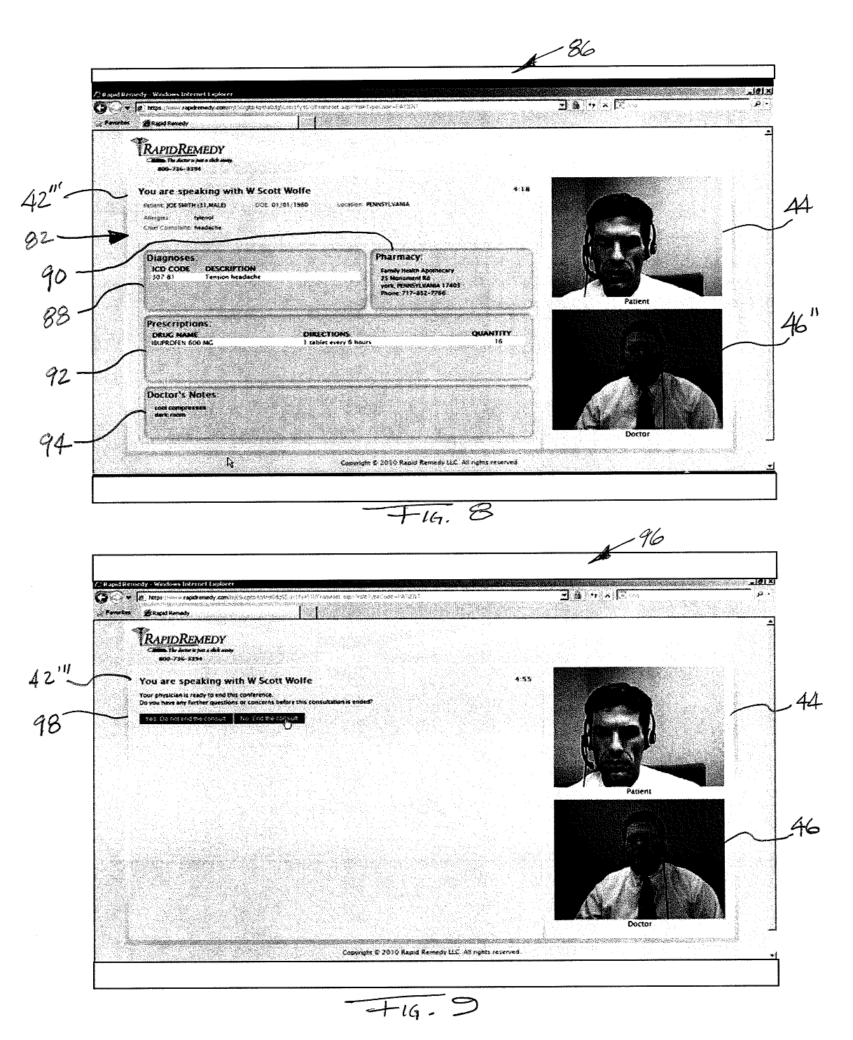

Referring to FIG. 7, the doctor is connected through the doctor's computing device 26 to provide a virtual office visit with the patient, and the doctor is displayed in the updated service camera view 46″. Although a referral may be made, preferably no advertisements will be shown while the patient is talking to the doctor. Preferably a diagnostic screen 82 is presented which can be seen by the user and the status bar 42′″ is updated to indicate the patient is connected with the doctor. As shown in FIG. 8, the diagnostic field 82 shown in screen 86 can be updated with a patient diagnosis at 88, a preferred pharmacy at 90, a prescription that is delivered to the pharmacy at 92, as well as any additional doctor notes regarding the symptoms and/or additional treatments available at 94. The doctor and patient can see one another via the cameras 28 on the respective computing devices 22, 26 and the display area provided at 44 and 46″. This allows an interactive virtual patient visit to the doctor which the doctor can respond directly to any specific questions of the patient.

When the virtual office visit is complete as shown in FIG. 9 at screen 96, the patient can sign off ending the virtual office visit via clicking on the query provided at 98.

The present system 10 provides targeted advertisement in an existing internet based, video conferencing, web application for patient care that targets advertising to specific patient needs during the time period that a patient waits for a receptionist to answer a call as well as during a time period that the patient is waiting in a queue for a doctor for a virtual visit. This provides unique advertising space for various companies with health related services as well as other services and products.

The rule set used for selecting different advertising based on weighting of various patient demographics and information can be done in a variety of different ways. Revenue can be generated based on clicks on specific advertising or based on advertising frequency and duration. Alternative internet advertising payment schemes can also be used. It may also be possible to provide URLs with click-through connections to open in separate windows that can be viewed by the patient while maintaining the window for the system 10 open and active while either waiting for the receptionist or in the doctor queue.

It will be appreciated by those skilled in the art that the embodiments and methods described above are considered to be merely exemplary and that the specific examples provided are not considered limiting. Further, the invention includes various combinations and sub-combinations of the system configuration and methods of implementation discussed above.

What is claimed is:

1. An on-line physician care system, comprising:
an on-line physician care system server and an ad server provided as a part of or separately from the system server, including at least one processor and a memory with computer readable instructions, the system server with the computer readable instructions being configured to:
access patient data for a patient logging into the system with a patient computing device;
place the patient computing device logging into the system in a queue state by displaying a queue screen on the patient computing device;
cause the ad server to display advertising on the queue screen that is targeted to the patient during a time that the patient is waiting in the queue state; and
connect the patient computing device and a doctor computing device and establish audio and visual communication between the patient and the doctor computing devices.

2. The on-line physician care system of claim 1, further comprising:
the system server with the computer readable instructions being configured to:
connect the patient computing device to a receptionist computing device and establish an audio and video connection between the patient and the receptionist computing devices.

3. The on-line physician care system of claim 2, further comprising:
the system server being configured to
place the patient in the queue state and display the queue screen with targeted advertising until a receptionist can be connected to the patient via the connection between the patient computing device and the receptionist computing device.

4. The on-line physician care system of claim 2, further comprising:
the system server being configured to receive additional data from the patient that is entered into the system server via at least one of the receptionist or the patient computing devices.

5. The on-line physician care system of claim 4, further comprising:
the system server being configured to
cause the ad server to display advertising targeted to the patient via the patient computing device during a time that the patient computing device is waiting in the queue state for connection to the doctor computing device, the advertising being targeted based on patient data in the system server, received from the patient computing device, or entered by the receptionist.

6. The on-line physician care system of claim 1, further comprising at least one patient computing device and at least one doctor computing device, each of which is connected to the system server, each of the computing devices being equipped with a camera, a speaker and a microphone.

7. The on-line physician care system of claim 6, further comprising at least one receptionist computing device which is connected to the system server, the receptionist computing devices being equipped with a camera, a speaker and a microphone.

8. The on-line physician care system of claim 1, further comprising:
the system server being configured to display a status indicator on the patient computing device.

9. The on-line physician care system of claim 8, further comprising:
the system server being configured to update the status indicator on the patient computing device to indicate a connection to the doctor computing device.

10. The on-line physician care system of claim 1, further comprising:
the system server being configured to display a diagnostic screen on the patient computing device upon connection to the doctor computing device.

11. The on-line physician care system of claim 1, further comprising:
the system server being configured to display a preferred pharmacy and a prescription entered from the doctor computing device that is delivered to the pharmacy on the patient computing device.

12. The on-line physician care system of claim 1, further comprising:
the system server being configured to receive and store patient data that is entered via at least one of a receptionist computing device or the patient computing device.

13. The on-line physician care system of claim 12, further comprising:
the system server being configured to display patient specific information including at least one of a patient name, birth date, address, phone, e-mail, or employer on the patient computing device.

14. The on-line physician care system of claim 13, further comprising:
the system server being configured to receive updates of the patient specific information by at least one of the patient computing device or the receptionist computing device.
